(19) United States
(12) Patent Application Publication
(10) Pub. No.: US 2020/0239033 A1
(43) Pub. Date: Jul. 30, 2020

(54) PROCESSING DEVICE, PROCESSING METHOD, AND PROGRAM

(71) Applicant: TOYOTA JIDOSHA KABUSHIKI KAISHA, Toyota-shi (JP)

(72) Inventors: Kunihiro MURAKAMI, Okazaki-shi (JP); Katsuhiko SAKAKIBARA, Kariya-shi (JP); Makoto MATSUSHITA, Ichinomiya-shi (JP); Junya SATO, Nagoya-shi (JP); Kiyonori YOSHIDA, Toyota-shi (JP); Tae SUGIMURA, Miyoshi-shi (JP); Takashi HAYASHI, Aichi-gun (JP); Jun ENDO, Nagoya-shi (JP)

(73) Assignee: TOYOTA JIDOSHA KABUSHIKI KAISHA, Toyota-shi (JP)

(21) Appl. No.: 16/749,010

(22) Filed: Jan. 22, 2020

(30) Foreign Application Priority Data
Jan. 24, 2019 (JP) 2019-010570

(51) Int. Cl. B60W 60/00; G06Q 30/06; G01C 21/36; G06Q 10/08; G06Q 10/06

(52) U.S. Cl. CPC B60W 60/00256; G06Q 30/0631; G06Q 30/0639; G01C 21/3623; G06Q 10/08355; G06Q 10/0635; G01C 21/3697

(57) ABSTRACT

A processing device performs: acquiring first information on one or more commodities of which purchase is to be recommended based on a travel schedule of a vehicle; identifying one or more users based on a route that the vehicle is scheduled to travel; transmitting second information for recommending purchase of the one or more commodities based on the first information to the identified user; and controlling travel of the vehicle such that a commodity is picked up and is then delivered to a user who has returned a reply of desiring purchase of the commodity when the reply has been returned from the user.

### INCORPORATION BY REFERENCE

The disclosure of Japanese Patent Application No. 2019-010570 filed on Jan. 24, 2019 including the specification, drawings and abstract is incorporated herein by reference in its entirety.

### BACKGROUND

### 1. Technical Field

The disclosure relates to a technique for controlling a vehicle that delivers commodities.

### 2. Description of Related Art

In the related art, when a commodity is purchased using an online shopping service, a vendor of the commodity entrusts a delivery service provider with delivery of the commodity to a purchaser, and the delivery service provider delivers the commodity to an address which is designated by the purchaser. A technique of receiving luggage such as commodities in the related art is as follows. For example, by providing a user's schedule information to a management server which is installed in a home delivery service provider via a network and combining the schedule information with schedule information of a person in charge of pickup and delivery, map information, traffic information, and the like, the optimal route and date and time of pickup and delivery can be determined (Japanese Patent Application Publication No. 2003-020120 (JP 2003-020120 A)).

### SUMMARY

When commodities are purchased using an online shopping service, the commodities are sent from a shop to a sending-side delivery center, are transported to a receiving-side delivery center along with other commodities, and are delivered from the receiving-side delivery center to a home by a delivery vehicle. In this way, much labor is required for delivery.

The disclosure provides a technique through which it is possible to achieve improvement in efficiency of an operation of delivering commodities.

According to a first aspect of the disclosure, there is provided a processing device including a control unit configured to perform: acquiring first information on one or more commodities of which purchase is to be recommended based on a travel schedule of a vehicle; identifying one or more users based on a route that the vehicle is scheduled to travel; transmitting second information for recommending purchase of the one or more commodities based on the first information to the identified user; and controlling travel of the vehicle such that a commodity is picked up and is then delivered to a user who has returned a reply of desiring purchase of the commodity when the reply has been returned from the user.

The control unit may be configured to acquire the first information from a web page of a shop which is identified based on the travel schedule of the vehicle.

The control unit may be configured to generate the second information based on an image from the traveling vehicle having imaged the shop and the first information.

The control unit may be configured to acquire a time at which the commodity is delivered to the user based on the route and to notify the user of the time.

According to a second aspect of the disclosure, there is provided a processing method of causing an information processing device to perform: acquiring first information on one or more commodities of which purchase is to be recommended based on a travel schedule of a vehicle; identifying one or more users based on a route that the vehicle is scheduled to travel; transmitting second information for recommending purchase of the one or more commodities based on the first information to the identified user; and controlling travel of the vehicle such that a commodity is picked up and is then delivered to a user who has returned a reply of desiring purchase of the commodity when the reply has been returned from the user.

An information processing device that performs the processing method may acquire the first information from a web page of a shop which is identified based on the travel schedule of the vehicle. The information processing device may generate the second information based on an image from the traveling vehicle having imaged the shop and the first information. The information processing device may acquire a time at which the commodity is delivered to the user based on the route and notify the user of the time.

A third aspect of the disclosure provides a program causing a computer to perform the processing method or a non-transitory computer-readable storage medium having the program stored therein.

According to the disclosure, it is possible to achieve improvement in efficiency of an operation of delivering commodities.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a mail-order system according to a first embodiment;

FIG. 2 is a block diagram schematically illustrating an example of a vehicle;

FIG. 3 is a diagram illustrating appearance of a vehicle;

FIG. 4 is a diagram illustrating an example of a user table;

FIG. 5 is a diagram schematically illustrating an example of a shop device;

FIG. 6 is a diagram illustrating an example of first information;

FIG. 7 is a diagram illustrating an example of inventory information;

FIG. 8 is a diagram schematically illustrating an example of user equipment;

FIG. 9 is a diagram illustrating a mail-order method according to the first embodiment;

FIG. 10 is a diagram illustrating a mail-order system according to a second embodiment;

FIG. 11 is a diagram schematically illustrating an example of a management server;

FIG. 12A is a diagram (a first half) illustrating a mail-order method according to the second embodiment;

FIG. 12B is a diagram (a second half) illustrating a mail-order method according to the second embodiment;

FIG. 13 is a diagram illustrating an example of a shop table;

FIG. 14 is a diagram illustrating a mail-order method according to a third embodiment;

FIG. 15 is a block diagram schematically illustrating an example of a vehicle according to a fourth embodiment;

FIG. 16A is a diagram (a first half) illustrating a mail-order method according to the fourth embodiment; and

FIG. 16B is a diagram (a second half) illustrating a mail-order method according to the fourth embodiment.

### DETAILED DESCRIPTION OF EMBODIMENTS

An online shopping service is convenient but requires much labor for delivering commodities, and delivery costs of the commodities are added to prices of the commodities. Accordingly, when it is intended to purchase a small amount of relatively cheap commodities such as foods and daily necessities, a delivery cost thereof may exceed a commodity price and thus it may be difficult to utilize an online shopping service. Cold-storage commodities and frozen commodities need to be delivered by a vehicle with cooling equipment, and therefore a delivery cost tends to increase and cold-storage commodities and frozen commodities which can be purchased using an online shopping service are restricted.

Therefore, a delivery processor according to an embodiment acquires information on commodities which are recommended to be purchased based on a travel schedule of a vehicle, transmits information for recommending purchase of commodities to users who are identified from routes that vehicles are scheduled to travel, and controls traveling of the vehicles such that commodities are delivered to users who desire to purchase the commodities.

A travel schedule of a vehicle is, for example, a travel schedule which is represented by a direction, a position, a road, and an area in which the vehicle is to travel. Such a schedule of a direction, a position, and the like may be determined along with a time. A travel schedule may include a schedule of a route which is represented by continuity of the direction, the position, and the road. A travel schedule is not limited a fixed schedule and can change depending on the situation. For example, when a travel schedule is to circulate on a route including points A to C in a predetermined area and a task of loading and carrying a passenger with a shared vehicle or a task of delivering commodities is instructed, the route may be changed such that the task is incorporated into the schedule.

Then, the delivery processing device according to the embodiment acquires information on commodities from a shop close to a predetermined area or the like based on the travel schedule of the vehicle and identifies users who desire to purchase the commodities in the vicinity of the route. That is, the delivery processing device according to the embodiment matches a shop which sells commodities with a user who purchases the commodities in the vicinity of a place in which the vehicle is scheduled to travel and delivers the commodities from the shop to the user.

Accordingly, the delivery processing device according to the embodiment can consistently pick up commodities in a selling-side shop and send the picked-up commodities to a user using a single vehicle instead of using a delivery center or the like, whereby it is possible to achieve improvement in efficiency of delivery and to decrease costs associated with delivery. By identifying a user near a shop and receiving a request for purchase of commodities from the user instead of receiving a request for purchase of commodities from unspecified users, cold-storage commodities and frozen commodities can be delivered with a vehicle not having special cooling equipment and types of commodities which are handled by online shopping (hereinafter also referred to as mail-order) can be expanded.

In the embodiment, a vehicle is not limited to a truck in which commodities are loaded and may be a passenger vehicle such as a taxi or a sharing vehicle, a bus, or a truck.

Hereinafter, specific embodiments of the disclosure will be described with reference to the accompanying drawings. Hardware configurations, module configurations, functional configurations, and the like which are described in the embodiments are not intended to limit the technical scope of the disclosure unless otherwise mentioned.

### First Embodiment

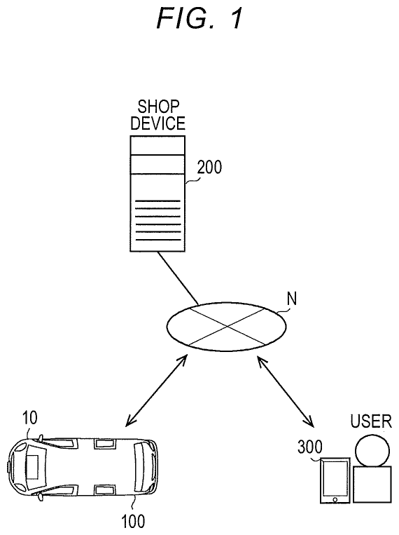

FIG. 1 is a diagram illustrating a mail-order system according to a first embodiment. The mail-order system according to this embodiment includes a vehicle 100 that can travel autonomously and a control device 10 that controls traveling of the vehicle 100. A shop device 200 transmits information on commodities which are to be recommended (first information) to the control device 10 and user equipment 300 transmits a request for purchase to the control device 10 when a when a user desires to purchase commodities.

In the mail-order system according to the embodiment, the control device 10 acquires first information from a shop device 200 which is located near a vehicle 100 and transmits information of commodities of which purchase is recommended to a user who is specified based on a travel route of the vehicle 100 (second information). When a request for purchase is received from user equipment 300, the control device 10 of the mail-order system controls travel of the vehicle 100 and delivers the commodities from the shop to the user. A home delivery system according to this embodiment does not include a shop device 200 and user equipment 300, but a home delivery system may include a shop device 200 or user equipment 300.

The vehicle 100 is an automatically driven vehicle that performs pickup and delivery of commodities. The vehicle 100 is also referred to as an electric vehicle (EV) pallet. The vehicle 100 is not necessarily an unmanned vehicle. For example, occupants such as sales staff, service staff, or security personnel may be in the vehicle 100. The vehicle 100 may not be a vehicle that can travel completely autonomously. For example, the vehicle 100 may be a vehicle which is driven by a person or of which driving is assisted by a person depending on the situation. In this embodiment, the vehicle 100 can travel to a pickup destination or a delivery destination which is determined by the control device 10 and pick up or deliver luggage. The vehicle 100 may have a function of loading a passenger and traveling to a destination which is designated by the passenger.

The shop device 200 is provided in a shop that sells commodities, and transmits first information of commodities which are to be sold to the control device 10. The shop device 200 transmits first information to the control device 10, for example, by short-range radio communication with a communication range of about several tens of m to 100 m such as WiFi or Bluetooth (registered trademark). That is, when a vehicle 100 in which the control device 10 is mounted passes by the vicinity of the shop and enters a reachable range of radio waves of short-range radio communication, the shop device 200 transmits first information to the control device 10.

The user equipment 300 receives second information from the control device 10 and displays the second information to present information of commodities. When a user performs an operation for purchasing the presented commodities, the user equipment 300 transmits a request for purchase of the commodities to the control device 10.

The control device 10 is mounted in the vehicle 100, transmits second information of recommending purchase of commodities to the user equipment 300, and controls travel of the vehicle 100 such that pickup and delivery of the commodities are performed in response to a request for purchase of the commodities. The control device 10 is an example of a processing device or an information processing device.

### System Configuration

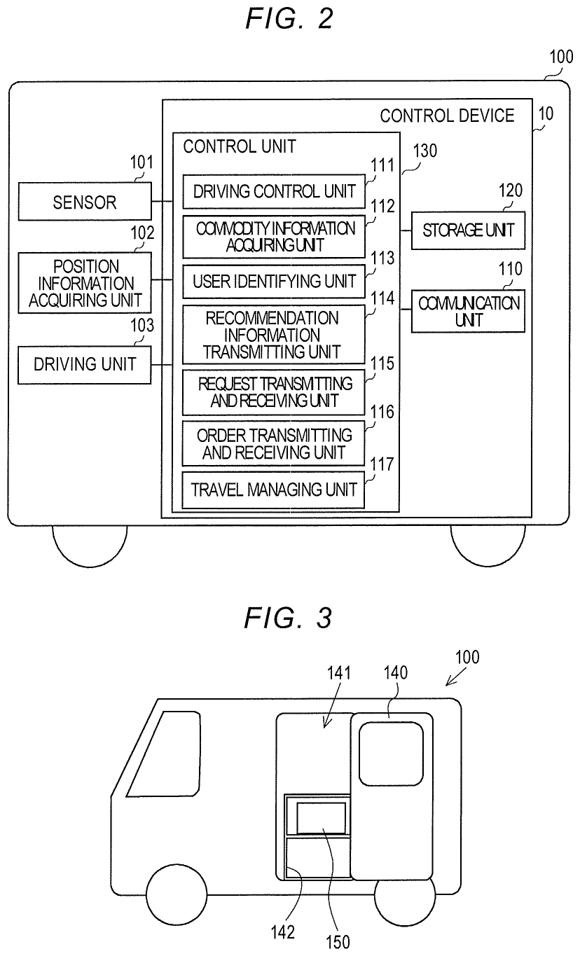

Elements of the system will be described below in detail. FIG. 2 is a block diagram schematically illustrating an example of the vehicle 100. The vehicle 100 includes a sensor 101, a position information acquiring unit 102, a driving unit 103, and a control device 10. The vehicle 100 operates with electric power which is supplied from a battery which is not illustrated.

The sensor 101 is a unit that senses surroundings of the vehicle and typically includes a stereo camera, a laser scanner, a light detection and ranging, laser imaging detection and ranging (LIDAR), and a radar. Information which is acquired by the sensor 101 is transmitted to the control device 10. The sensor 101 includes sensors for allowing the host vehicle to travel autonomously. The sensor 101 may include a camera which is provided in a vehicle body of the vehicle 100. For example, the sensor 101 may include an imaging device using an image sensor such as a charge-coupled device (CCD), a metal-oxide-semiconductor (MOS), or a complementary metal-oxide-semiconductor (CMOS). A plurality of cameras may be provided at a plurality of positions on the vehicle body. For example, cameras may be provided on the surfaces of the front, rear, right, and left sides of the vehicle body. The sensor 101 may be a unit that senses a state of the vehicle 100. For example, the sensor 101 may include an acceleration sensor, a vehicle speed sensor, a steering angle sensor, a gyro sensor, and a geomagnetic sensor.

The position information acquiring unit 102 is a unit that acquires a current position of the vehicle 100 and typically includes a Global Positioning System (GPS) receiver. Information which is acquired by the position information acquiring unit 102 is transmitted to the control device 10.

The driving unit 103 is a unit that causes the vehicle 100 to travel based on a control signal which is generated by the control device 10. The driving unit 103 includes, for example, a motor or an inverter that drives vehicle wheels, a brake, a steering mechanism, and a secondary battery.

The vehicle 100 includes a unit that loads luggage into the vehicle 100. FIG. 3 is a diagram illustrating the exterior of the vehicle 100 and illustrates a state in which a door 140 of a passenger compartment 141 is open. As illustrated in FIG. 3, the vehicle 100 includes a loading device 142 such as a shelf on which luggage is loaded in the passenger compartment 141, and can load commodities 150 on the loading device 142. In the example illustrated in FIG. 3, only one piece of luggage 150 is illustrated, but the vehicle 100 is configured to have a plurality of pieces of luggage loaded thereon. The loading device 142 is not necessary and the luggage 50 may be placed horizontally in the passenger compartment 141 or the luggage 50 may be stored on a seat. The vehicle 100 may include a mechanism that hands over only a predetermined piece of luggage out of a plurality of pieces of luggage. For example, a storage device including a plurality of storage areas (also referred to as blocks) may be provided in the passenger compartment and only a permitted block may be opened. The vehicle 100 may include a mechanism that hands luggage stored therein over to another device. For example, the vehicle 100 may include a mechanism that is connected to an external storage device such as a home delivery locker and transfers luggage. The vehicle 100 may include an autonomous mobile object (an assistant robot) that loads luggage from a shop to the vehicle 100 or unloads and hands luggage over from the vehicle 100 to a user. The vehicle 100 may include a device that issues a receipt or a deposit receipt. The units such as such mechanisms or devices are controlled by the control device 10.

The control device 10 is a computer that controls the vehicle 100 based on information which is acquired from the sensor 101, the position information acquiring unit 102, and the like. The control device 10 includes a communication unit 110, a storage unit 120, and a control unit 130.

The communication unit 110 is an interface that communicates with another device such as the shop device 200 or the user equipment 300. The communication unit 110 can communicate with another device (for example, the user equipment 300) via a network N using a mobile communication service such as 3rd generation (3G) or Long Term Evolution (LTE). The communication unit 110 can communicate with another device (for example, the shop device 200) using short-range radio communication such as WiFi or Bluetooth.

The storage unit 120 is a unit that stores information and is constituted by a RAM or a storage medium such as a magnetic disk or a flash memory. The storage unit 120 serves as, for example, an auxiliary storage device of the control device 10 which is a computer. The storage unit 120 may be included as a main storage device of the control device 10 which is a computer in the control unit 130.

The control unit 130 is a unit that takes charge of control of the control device 10. The control unit 130 includes a processor such as a central processing unit (CPU) or a micro-processing unit (MPU). The control unit 130 includes a driving control unit 111, a commodity information acquiring unit 112, a user identifying unit 113, a recommendation information transmitting unit 114, a request transmitting and receiving unit 115, an order transmitting and receiving unit 116, and a travel managing unit 117 as functional modules. The control unit 130 may embody the functions of the functional modules by causing a multi-purpose processor to execute a program (software) which is stored in a storage unit such as a read only memory (ROM). Some or all of the functional modules may be a hardware circuit that embodies the functions by processing information in a combination of logical circuits or the like or a dedicated processor such as a DSP.

The driving control unit 111 controls the driving unit 103 based on a result of detection from the sensor 101 and causes the vehicle 100 to travel autonomously to a destination which is determined by the travel managing unit 117.

The commodity information acquiring unit 112 acquires first information on one or more commodities of which purchase is to be recommended based on a travel schedule of the vehicle. For example, the commodity information acquiring unit 112 acquires first information from shops which are located close to places (areas, positions, roads, and the like) in which the vehicle is scheduled to travel. Since the control device 10 according to this embodiment causes the vehicle to travel in accordance with the travel schedule and acquires first information from the shop device 200 by short-range radio communication, the control device 10 can acquire first information of shops which are located at close positions at which short-range radio communication is possible.

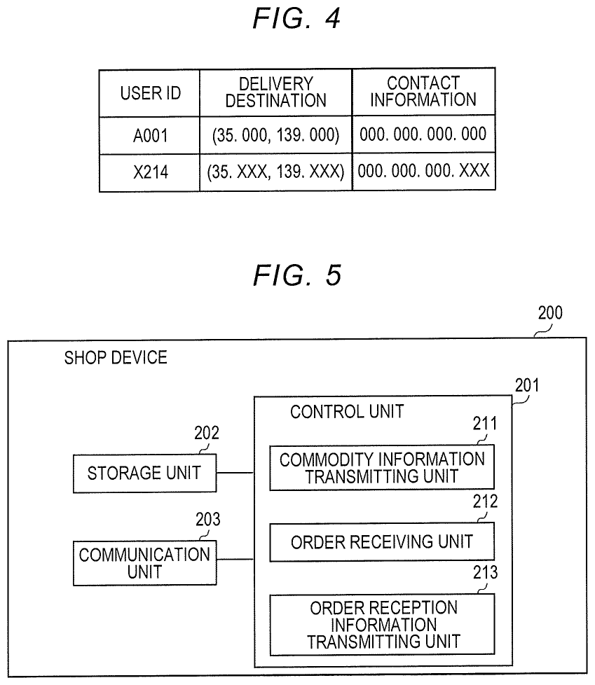

The user identifying unit 113 identifies one or more users based on a route that the vehicle 100 is scheduled to travel. The user identifying unit 113 identifies a user who desires a position close to the route that the vehicle 100 is scheduled to travel as a delivery destination, for example, with reference to a user table in which delivery destinations of commodities are stored for each user. FIG. 4 is a diagram illustrating an example of the user table. The user table includes a user ID, a delivery destination, and contact information. The user ID is information for uniquely identifying a user and examples thereof include a name or a number of the user. The delivery destination is information indicating a place to which commodities are to be delivered and examples thereof include the address and the latitude and longitude of the delivery destination. The contact information is a destination address which is used to transmit second information or order reception information to the user equipment 300 via the network N.

The recommendation information transmitting unit 114 transmits second information for recommending purchase of one or more commodities based on the first information to the identified user. The recommendation information transmitting unit 114 transmits order reception information indicating commodities of which order has been determined to the user equipment 300.

The request transmitting and receiving unit 115 receives a request for purchase indicating commodities of which purchase is desired by the user and transmits the request for purchase to the shop device 200 which is a transmission source of the first information.

The order transmitting and receiving unit 116 receives the order reception information from the shop information and transmits the order reception information to the user equipment 300 which has transmitted the request for purchase of commodities indicated by the order reception information. The order transmitting and receiving unit 116 may acquire a time of arrival of commodities at the delivery destination based on the travel route of the vehicle 100 or the time at which commodities are picked up, and transmit the arrival time along with the order reception information.

When a reply of desiring to purchase the commodities is acquired from the user, the travel managing unit 117 controls travel of the vehicle such that the commodities are picked up and then the commodities are delivered to the user who has transmitted the reply. The travel managing unit 117 may control the vehicle 100 such that the vehicle 100 travels in a predetermined area while finding a passenger such as when cruising in a taxi. The travel managing unit 117 may control the vehicle 100 such that the vehicle 100 travels along a specific fixed route like a fixed-route bus.

FIG. 5 is a diagram schematically illustrating an example of a shop device 200. A shop device 200 includes a communication unit 201, a storage unit 202, and a control unit 203. Similar to the communication unit 110, the communication unit 201 is an interface that communicates with another device. Particularly, the communication unit 201 in this embodiment communicates with the communication unit 110 of the vehicle 100 by short-range radio communication.

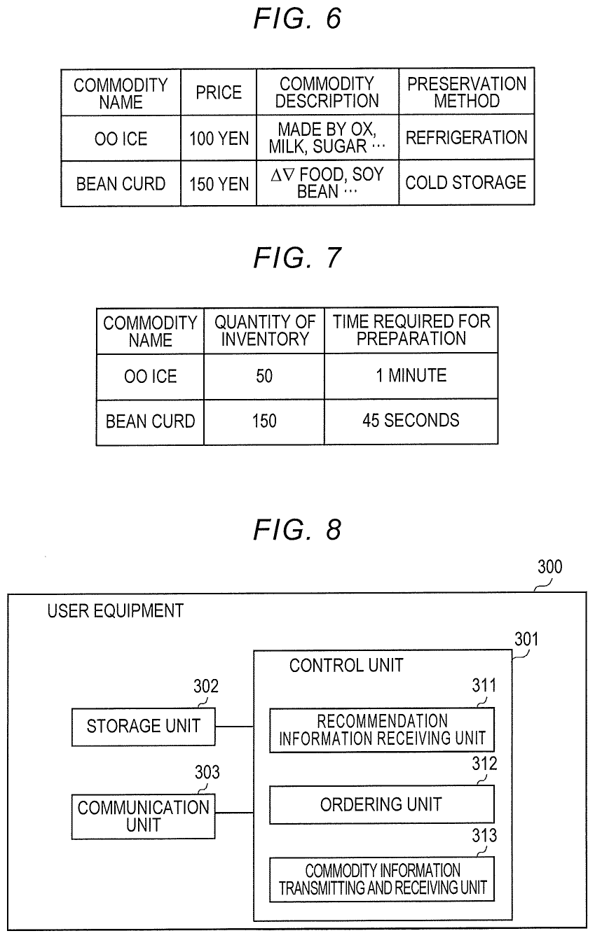

The storage unit 202 is a unit that stores information and is constituted by a RAM or a storage medium such as a magnetic disk or a flash memory. The storage unit 202 serves as, for example, an auxiliary storage device of the shop device 200 which is a computer. The storage unit 202 may be included as a main storage device of the shop device 200 which is a computer in the control unit 203. The storage unit 202 stores information of commodities such as first information or inventory information. FIG. 6 is a diagram illustrating an example of first information. The first information includes information such as commodity names, prices, commodity descriptions, and preservation methods. A commodity name is information for identifying a type of a commodity. A commodity description is information indicating details of a commodity such as components, a manufacturer, and a seller of the commodity. A preservation method is information indicating conditions for preserving a commodity such as storage at a normal temperature, cold storage, or refrigeration.

FIG. 7 is a diagram illustrating an example of inventory information. The inventory information includes information such as commodity names, quantities of stock, and times required for preparation. A time required for preparation is a time which is required for preparation for handing-over of the commodity to the vehicle 100 and is, for example, a time for taking the commodity off of a shelf on which the commodity is stored and a time for performing an accounting process and packing the commodity. When the commodity is to be cooked, the time required for preparation may include a cooking time.

The control unit 203 is a unit that takes charge of control of the shop device 200. The control unit 203 includes a processor such as a central processing unit (CPU) or a micro-processing unit (MPU). The control unit 203 includes a commodity information transmitting unit 211, an order receiving unit 212, and an order reception information transmitting unit 213 as functional modules. The control unit 203 may embody the functions of the functional modules by causing a multi-purpose processor to execute a program (software) which is stored in a storage medium such as a read only memory (ROM). Some or all of the functional modules may be a hardware circuit that embodies the functions by processing information in a combination of logical circuits or the like or a dedicated processor such as a DSP.

The commodity information transmitting unit 211 reads information of commodities which can be provided by an online shopping service using the vehicle 100 (first information) from the storage unit 202 and transmits the read information to the control device 10.

The order receiving unit 212 receives order information of commodities of which purchase is desired by a user from the control device 10 and receives the order of the commodities when there is an inventory with reference to the inventory information of the storage unit 202. The order receiving unit 212 may acquire a time at which the commodities can be handed over to the vehicle 100 based on the time required for preparation of the commodity.

The order reception information transmitting unit 213 transmits information of commodities of which the order is received by the order receiving unit 212 (order reception information) to the control device 10. The order reception information includes information such as the commodity name or the number of commodities of which the order has been received and the time at which the commodities can be handed over.

FIG. 8 is a diagram schematically illustrating an example of the user equipment 300. Examples of the user equipment 300 include a mobile terminal, a smartphone, and a personal computer. The user equipment 300 includes a communication unit 301, a storage unit 302, and a control unit 303. The communication unit 301 and the storage unit 302 of the user equipment 300 are the same as the communication unit 201 and the storage unit 202 of the shop device 200 and thus description thereof will not be repeated.

The control unit 303 is a unit that takes charge of control of the user equipment 300. The control unit 303 includes a processor such as a central processing unit (CPU) or a micro-processing unit (MPU). The control unit 303 includes a recommendation information receiving unit 311, an ordering unit 312, and a commodity information transmitting and receiving unit 313 as functional modules. The control unit 303 may embody the functions of the functional modules by causing a multi-purpose processor to execute a program (software) which is stored in a storage medium such as a read only memory (ROM). Some or all of the functional modules may be a hardware circuit that embodies the functions by processing information in a combination of logical circuits or the like or a dedicated processor such as a DSP.

The recommendation information receiving unit 311 receives second information from the control device 10. The ordering unit 312 displays the received second information on a display unit to present the second information to a user and to prompt the user to purchase commodities. When a commodity of which purchase is desired is input through the user's operation, the ordering unit 312 transmits the request for purchase of the commodity to the control device 10.

The commodity information transmitting and receiving unit 313 receives information on transaction of commodities such as order reception information of commodities of which order reception has been determined or a notification indicating that commodities arrive from the control device 10. The commodity information transmitting and receiving unit 313 transmits information on transaction of commodities such as a notification indicating that reception of commodities is started or a notification indicating that commodities are received to the control device 10.

### <Mail-Order Method>

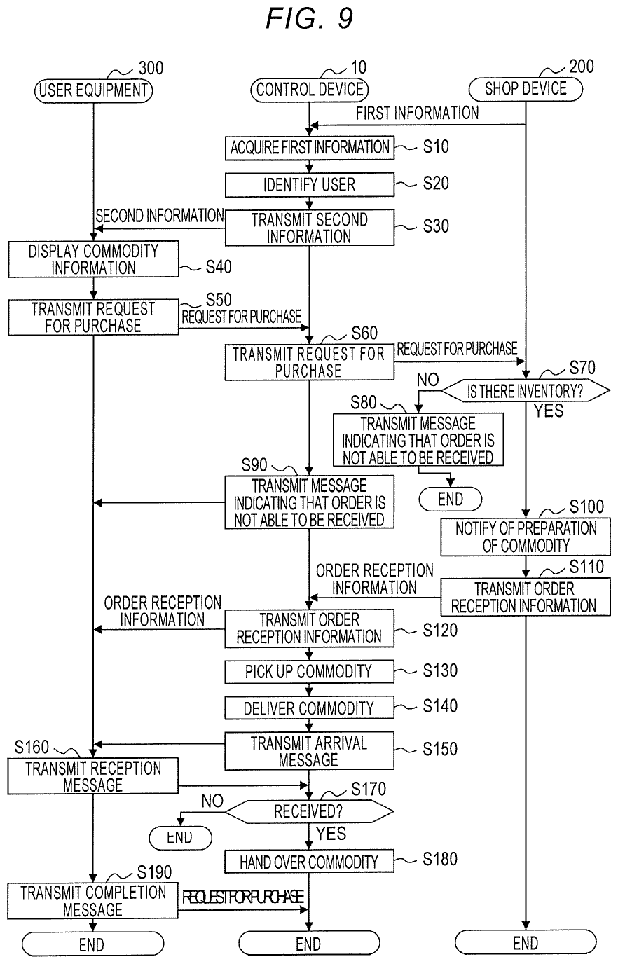

FIG. 9 is a diagram illustrating a mail-order method (a processing method) according to this embodiment. When the commodity information transmitting unit 211 of the shop device 200 transmits first information of commodities by short-range radio communication, the commodity information acquiring unit 112 of the control device 10 which is mounted in a vehicle 100 traveling in a communication range acquires the first information (Step S10).

The user identifying unit 113 of the control device 10 identifies a user to whom the first information is to be transmitted based on a route that the vehicle 100 is scheduled to travel. For example, the user identifying unit 113 extracts a user who sets a roadside of a route that the vehicle 100 is scheduled to travel as a delivery destination from a user table (Step S20).

The recommendation information transmitting unit 114 of the control device 10 transmits second information for recommending purchase of commodities to an address (contact information) of the identified user (Step S30).

When the second information transmitted to the address is received, the user equipment 300 displays information on commodities indicated by the second information on a display unit to present the second information to the user and to prompt the user to purchase the commodities (Step S40). When commodities of which purchase is desired is input by the user's operation, the ordering unit 312 transmits the request for purchase of the commodities to the control device 10 (Step S50).

When the request for purchase is received from the user equipment 300, the request transmitting and receiving unit 115 of the control device 10 transmits the request for purchase to the shop device 200 which has transmitted the first information of the commodities indicated by the request for purchase (Step S60).

When the request for purchase is received, the order receiving unit 212 of the shop device 200 determines whether there is an inventory of the requested commodities with reference to the inventory information (Step S70). When the determination result of Step S70 is negative, the order receiving unit 212 transmits a message indicating that the order cannot be received to the control device 10 and ends the process routine illustrated in FIG. 9 (Step S80). The order transmitting and receiving unit 116 of the control device 10 having received the message indicating that the order cannot be received transmits the message to the user equipment 300 (Step S90).

On the other hand, when the determination result of Step S70 is positive, the order receiving unit 212 of the shop device 200 notifies a staff of the shop of the information of the requested commodities, causes the staff to hand over the commodities to the vehicle 100 (Step S100), and transmits order reception information to the control device 10 (Step S110).

The order transmitting and receiving unit 116 of the control device 10 having received the order reception information transmits the order reception information to the user equipment 300 (Step S120). At the time of transmitting the order reception information, the shop device 200 may acquire a time (a pickup time) at which pickup of the commodities is possible based on a time which is required for preparation of the commodities and transmit the acquired time to the control device 10 along with the order reception information. The control device 10 may acquires a time at which the commodities arrive at the delivery destination based on the travel route of the vehicle 100 or the pickup time and transmit the arrival time along with the order reception information.

The travel managing unit 117 of the control device 10 having received the order reception information sets a shop for selling commodities indicated by the order reception information as a next destination in the driving control unit 111 and causes the vehicle 100 to travel to the shop and to pick up the commodities (Step S130) When the time at which pickup is possible is included in the order reception information, traveling may be controlled such that the vehicle 100 arrives on the time. In pickup of commodities, for example, the control device 10 may transmit a message to the shop device 200 at the time of arriving at the shop, call a person in charge of the shop, and cause the person in charge to load the commodities in the vehicle 100. A small-sized mobile object which moves autonomously may be mounted in the vehicle 100 and the commodities may be transferred from the shop to the vehicle 100 using the small-size mobile object.

When pickup of commodities is completed, the travel managing unit 117 notifies the driving control unit 111 of a delivery destination of the commodities as a next destination and causes the vehicle 100 to travel to the delivery destination of the commodities (Step S140).

When the vehicle 100 arrives at the delivery destination, the order transmitting and receiving unit 116 of the control device 10 transmits an arrival message indicating that commodities have arrived to the user equipment 300 (Step S150). The user equipment 300 having received the arrival message notifies the user of the arrival message and transmits a reception message indicating that reception of the commodities is started to the control device 10 when the user has performed an operation of approving of reception of the commodities (Step S160). When the reception message is not received within a predetermined period due to absence of the user or the like (NO in Step S170), the control device 10 ends the process routine illustrated in FIG. 9. On the other hand, when the reception message is received (YES in Step S170), the control device 10 unlocks a door or the like and hands over the commodities to the user (Step S180). In handover of the commodities, for example, the control device 10 may call the user by transmitting the arrival message to the user equipment 300 and cause the user to unload the commodities from the vehicle 100. The commodities may be unloaded from the vehicle 100 and handed over to the user using a small-size mobile object.

When the user performs an input operation for notifying that the commodities have been received, the user equipment 300 transmits a completion message to the control device 10 (Step S190). When the completion message is received, the control device 10 ends the process routine illustrated in FIG. 9. When the process routine illustrated in FIG. 9 ends, the travel managing unit 117 controls the vehicle 100 such that the vehicle 100 travels on a scheduled route.

In this way, in the mail-order system according to this embodiment, since shops located near vehicles and users close to a route that the vehicles are scheduled to travel are matched with each other and commodities are sold. Accordingly, instead of using a delivery center or the like at the time of delivery of commodities, commodities can be consistently picked up in a selling-side shop and the picked-up commodities can be sent to a user using a single vehicle 100, whereby it is possible to achieve improvement in efficiency of delivery. Accordingly, the mail-order system according to this embodiment can decrease costs associated with delivery and can be easily used when it is intended to purchase commodities with a low price or when it is intended to purchase a small amount of commodities.

Since users close to a shop are identified, a delivery time required for sending commodities from a shop to a user is short and it is possible to deliver cold-storage commodities and frozen commodities with a vehicle not having special cooing equipment and to expand types of commodities which are handled.

### Second Embodiment

A second embodiment employs a configuration in which some functions which are performed by the control device 10 in the first embodiment are performed by a server. The other configurations are the same as in the first embodiment and description thereof will not be repeated by referring to the same elements by the same reference signs, or the like.

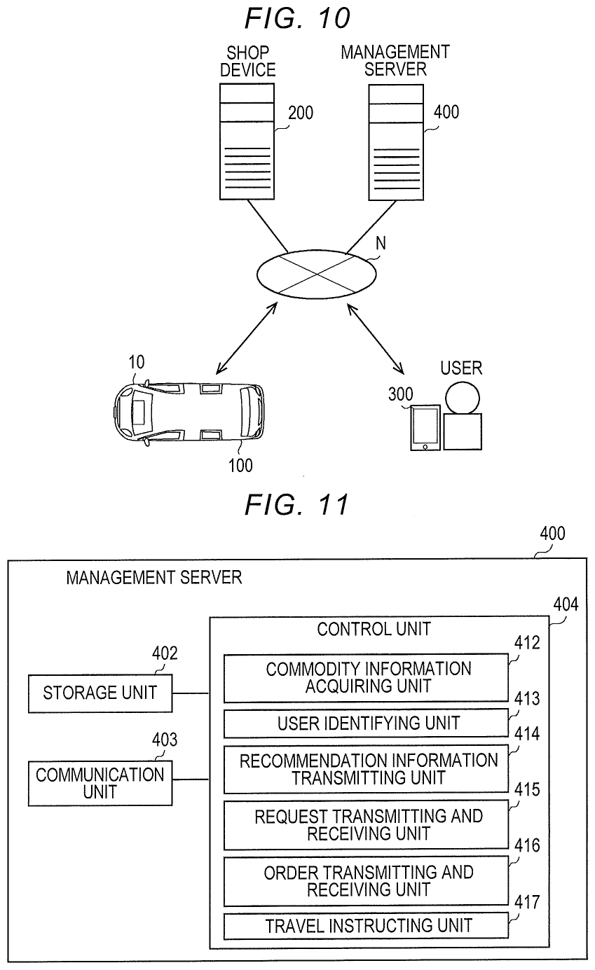

FIG. 10 is a diagram illustrating a mail-order system according to the second embodiment. The mail-order system according to this embodiment includes a management server 400 in addition to a vehicle 100 and a control device 10 which is mounted in the vehicle 100.

FIG. 11 is a diagram schematically illustrating an example of the management server 400. The management server 400 includes a communication unit 401, a storage unit 402, and a control unit 403. The communication unit 401 is a communication interface that communicates with another device via a network N.

The storage unit 402 is a unit that stores information and is constituted by a RAM or a storage medium such as a magnetic disk or a flash memory. The storage unit 402 serves as, for example, an auxiliary storage device of the management server 400 which is a computer. The storage unit 402 may be included as a main storage device of the management server 400 which is a computer in the control unit 403.

The control unit 403 is a unit that takes charge of control of the management server 400. The control unit 403 includes a processor such as a central processing unit (CPU) or a micro-processing unit (MPU). The control unit 403 includes a commodity information acquiring unit 412, a user identifying unit 413, a recommendation information transmitting unit 414, a request transmitting and receiving unit 415, an order transmitting and receiving unit 416, and a travel instructing unit 417 as functional modules. The control unit 403 may embody the functions of the functional modules by causing a multi-purpose processor to execute a program (software) which is stored in a storage medium such as a read only memory (ROM). Some or all of the functional modules may be a hardware circuit that embodies the functions by processing information in combination of logical circuits or the like or a dedicated processor such as a DSP.

The commodity information acquiring unit 412 acquires first information on one or more commodities from the control device 10 of a vehicle 100 via the network N.

The user identifying unit 413 stores routes on which vehicles 100 are scheduled to travel in advance and identifies one or more users based on the routes. The user identifying unit 413 identifies a user who desires a position close to the route that a vehicle 100 is scheduled to travel as a delivery destination, for example, with reference to a user table in which delivery destinations of commodities are stored for each user.

The recommendation information transmitting unit 414 transmits second information for recommending purchase of one or more commodities based on the first information to the identified user. The recommendation information transmitting unit 414 transmits order reception information indicating commodities of which order has been determined to the user equipment 300.

The request transmitting and receiving unit 415 receives a request for purchase indicating commodities of which purchase has been desired by the user and transmits the request for purchase to the shop device 200 which is a transmission source of the first information.

The order transmitting and receiving unit 416 receives the order reception information from the shop information and transmits the order reception information to the user equipment 300 which has transmitted the request for purchase of commodities indicated by the order reception information.

When the order reception information has been received from the shop device 200, the travel instructing unit 417 picks up commodities indicated by the order reception information and then transmits travel instructing information to the control device 10 of the vehicle 100 such that the commodities are sent to the user.

When the commodity information acquiring unit 112 has received the first information from the shop device 200, the control device 10 in the second embodiment transmits the first information to the management server 400. Then, the travel managing unit 117 performs pickup or delivery of commodities based on the travel instructing information which is acquired from the management server 400. In this way, in the second embodiment, since identification of a user, communication with the user equipment 300, and the like are performed by the management server 400, the user identifying unit 113, the recommendation information transmitting unit 114, the request transmitting and receiving unit 115, and the order transmitting and receiving unit 116 of the control device 10 may be removed. Instead of removing them, a case in which identification of a user, communication with the user equipment 300, and the like are performed by the management server 400 and a case in which the operations are performed by the control device 10 as in the first embodiment may be switched depending on commodities to be purchased, shops, users, or the like.

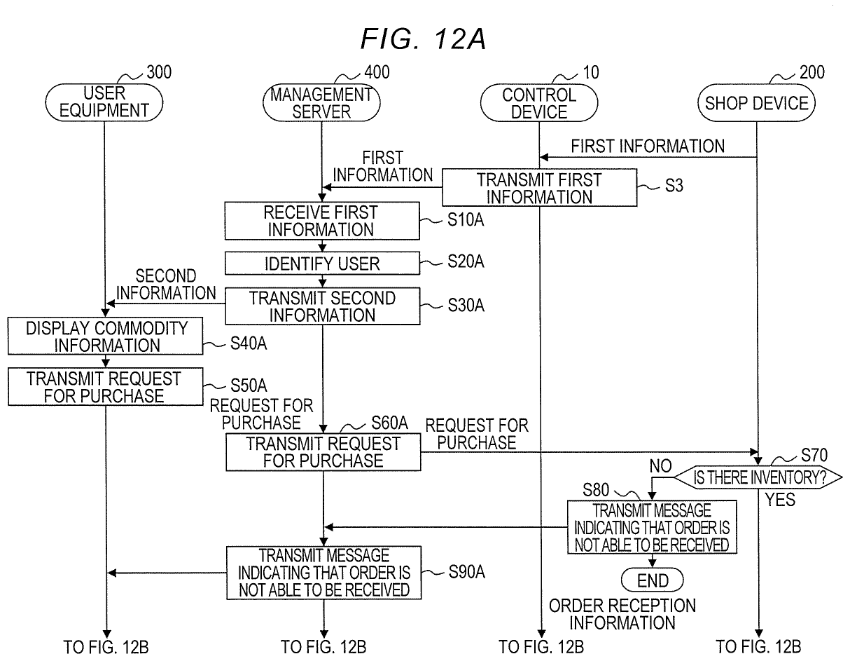

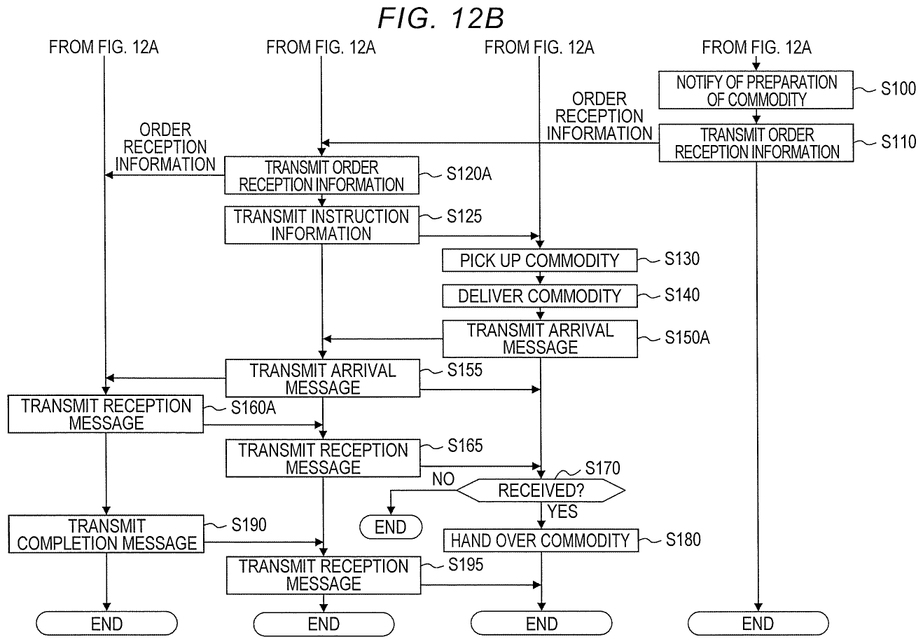

FIGS. 12A and 12B are diagrams illustrating a mail-order method according to the second embodiment. When the commodity information transmitting unit 211 of the shop device 200 transmits first information of commodities by short-range radio communication, the commodity information acquiring unit 112 of the control device 10 which is mounted in a vehicle 100 traveling in a communication range acquires the first information and transmits the first information to the management server 400 (Step S3) and the commodity information acquiring unit 412 of the management server 400 receives the first information (Step S10A).

The user identifying unit 413 of the management server 400 identifies a user to whom the first information is to be transmitted based on a route that the vehicle 100 is scheduled to travel (Step S20A).

The recommendation information transmitting unit 414 of the management server 400 transmits second information for recommending purchase of commodities to an address (contact information) of the identified user (Step S30A).

When the second information transmitted to the address is received, the user equipment 300 displays information on commodities indicated by the second information on a display unit to present the second information to the user and to prompt the user to purchase the commodities (Step S40). When commodities of which purchase is desired are input by the user's operation, the ordering unit 312 transmits the request for purchase of the commodities to the management server 400 (Step S50A).

When the request for purchase is received from the user equipment 300, the request transmitting and receiving unit 415 of the management server 400 transmits the request for purchase to the shop device 200 which has transmitted the first information of the commodities indicated by the request for purchase (Step S60A).

When the request for purchase is received, the order receiving unit 212 of the shop device 200 determines whether there is an inventory of the requested commodities with reference to the inventory information (Step S70). When the determination result of Step S70 is negative, the order receiving unit 212 transmits a message indicating that the order cannot be received to the management server 400 and ends the process routine illustrated in FIG. 12A (Step S80). The order transmitting and receiving unit 416 of the management server 400 having received the message indicating that the order cannot be received transmits the message to the user equipment 300 (Step S90A).

On the other hand, when the determination result of Step S70 is positive, the order receiving unit 212 of the shop device 200 notifies a staff of the shop of the information of the requested commodities, causes the staff to hand over the commodities to the vehicle 100 (Step S100), and transmits order reception information to the management server 400 (Step S110A).

The order transmitting and receiving unit 416 of the management server 400 having received the order reception information transmits the order reception information to the user equipment 300 (Step S120A). At the time of transmitting the order reception information, the shop device 200 may acquire a time at which pickup of the commodities is possible based on a time which is required for preparation of the commodities and transmit the acquired time to the management server 400 along with the order reception information.

The travel instructing unit 417 of the management server 400 having received the order reception information transmits instruction information for setting a shop for selling commodities indicated by the order reception information as a next destination to the control device 10 (Step S125). The control device 10 having received the instruction information sets a next destination in the driving control unit 111 based on the instruction information and causes the vehicle 100 to travel to the shop and to pick up the commodities (Step S130). When the time at which pickup is possible is included in the instruction information, traveling may be controlled such that the vehicle 100 arrives on the time.

When pickup of commodities is completed, the travel managing unit 117 notifies the driving control unit 111 of a delivery destination of the commodities as a next destination and causes the vehicle 100 to travel to the delivery destination of the commodities (Step S140).

When the vehicle 100 arrives at the delivery destination, the control device 10 notifies the management server 400 (Step S150A) and the order transmitting and receiving unit 416 of the management server 400 transmits an arrival message indicating that commodities have arrived to the user equipment 300 (Step S155). The user equipment 300 having received the arrival message notifies the user of the arrival message and transmits a reception message indicating that reception of the commodities is started to the management server 400 when the user has performed an operation of approving of reception of the commodities (Step S160A). The management server 400 having received the reception message transmits the reception message to the control device 10 (Step S165).

When the reception message is not received within a predetermined period due to absence of the user or the like (NO in Step S170), the control device 10 ends the process routine illustrated in FIG. 12B. On the other hand, when the reception message is received (YES in Step S170), the control device 10 unlocks a door or the like and hands over the commodities to the user (Step S180).

When the user performs an input operation for indicating that the commodities have been received, the user equipment 300 transmits a completion message to the management server 400 (Step S190). When the completion message is received, the management server 400 transmits the reception message to the control device 10 (Step S195). When the reception message is received, the travel managing unit 117 ends the process routine illustrated in FIG. 12B and controls the vehicle 100 such that the vehicle 100 travels on a scheduled route.

In this way, in the mail-order system according to the second embodiment, since identification of a user, communication with the user equipment 300, and the like are performed by the management server 400, it is possible to reduce a process load of the control device 10. Information of users can be together managed by the management server 400.

### Third Embodiment

The control device 10 acquires first information from a shop device 200 by short-range radio communication in the first embodiment, but a third embodiment employs a configuration in which the control device 10 acquires first information via the network N such as the Internet. The other configurations are the same as in the first embodiment and thus description thereof will not be repeated by referring to the same elements by the same reference signs, or the like.

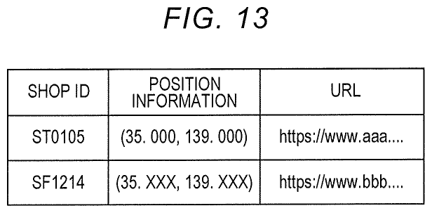

In the control device 10 according to this embodiment, a shop table in which position information of a plurality of shops is recorded is stored in the storage unit 120. FIG. 13 is a diagram illustrating an example of the shop table. As illustrated in FIG. 13, the shop table includes the fields of shop ID, position information, and URL. The shop ID is information for uniquely identifying a shop and examples thereof include a shop name and a shop number. The shop information is information indicating a position of a shop and examples thereof include an address of the shop and the latitude and longitude thereof. The URL is an URL of a web page in which commodities which are sold by the shop are listed. When the control device 10 acquires the URL of the web page from the shop ID using a search engine, the URL of the shop table may be omitted. When the control device 10 acquires first information from a shop device 200, the shop table may include a network address of the shop device 200.

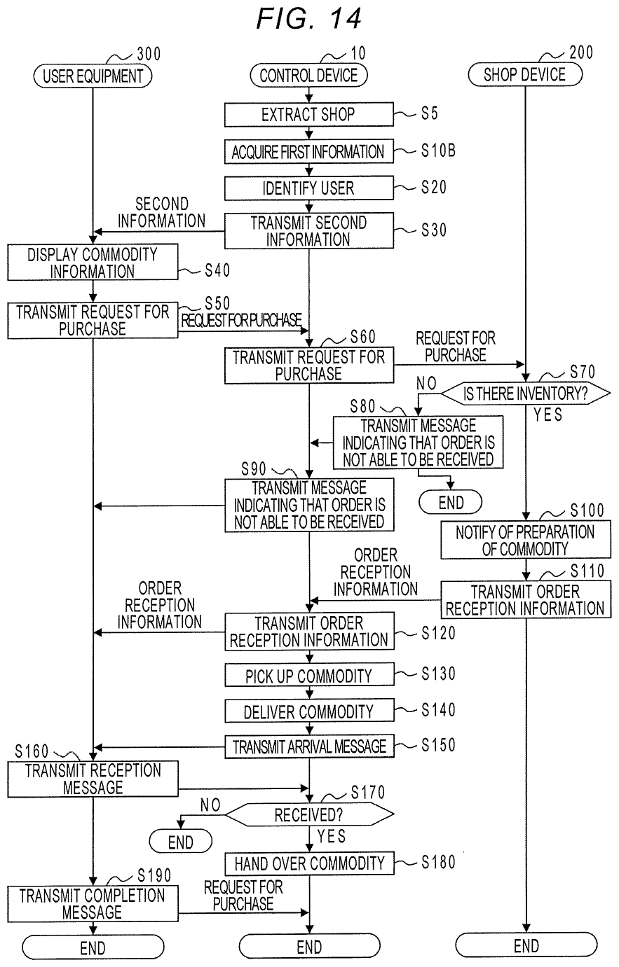

FIG. 14 is a diagram illustrating a mail-order method according to this embodiment. The control device 10 starts the process routine illustrated in FIG. 14 at a predetermined time such as a predetermined period or a specific time. The control device 10 extracts shops which are located close to a route that a vehicle is scheduled to travel with reference to the shop table (Step S5). Then, the control device 10 accesses a web page of each shop based on the URLs of the extracted shops, and acquires information such as commodity names or prices of commodities which are listed in the web page as first information (Step S10B). Instead of acquiring the first information from the web pages, the first information may be acquired from the shop devices 200 of the shops extracted in Step S5 via the network N. The processes of Step S20 and steps subsequent thereto such as transmitting second information to the user equipment 300 based on the first information are the same as in FIG. 9 and thus description thereof will not be repeated.

In this way, in this embodiment, since first information of shops which are located close to a route that a vehicle is scheduled to travel is acquired, the first information can be acquired before the vehicle 100 approaches the shop. Accordingly, when there is a request for purchase of commodities indicated by the first information, the vehicle 100 can pick up the commodities at the time of arrival at the vicinity of the shop and it is possible to improve efficiency of a pickup operation. In this embodiment, since the first information can be acquired from a web page of a shop, a staff of the shop does not need to input the first information to the shop device 200 separately from the web page and it is thus possible to reduce the staff's labor.

In this embodiment, the configurations other than the configuration for acquiring first information are the same as in the first embodiment, but the disclosure is not limited thereto and the other configurations may be the same as in the second embodiment. For example, the management server according to the second embodiment may perform the same processes as Steps S5 and S10B and then perform the processes of Step S20A and steps subsequent thereto similarly to FIGS. 12A and 12B. In addition to Steps S5 and S10B, the first information may be acquired by short-range radio communication similarly to Steps S10 and S10A in the first or second embodiment.

### Fourth Embodiment

A fourth embodiment is different from the third embodiment in the configuration for generating second information based on an image obtained by imaging a shop and first information. The other configurations are the same as in the third embodiment and thus description thereof will not be repeated by referring to the same elements by the same reference signs.

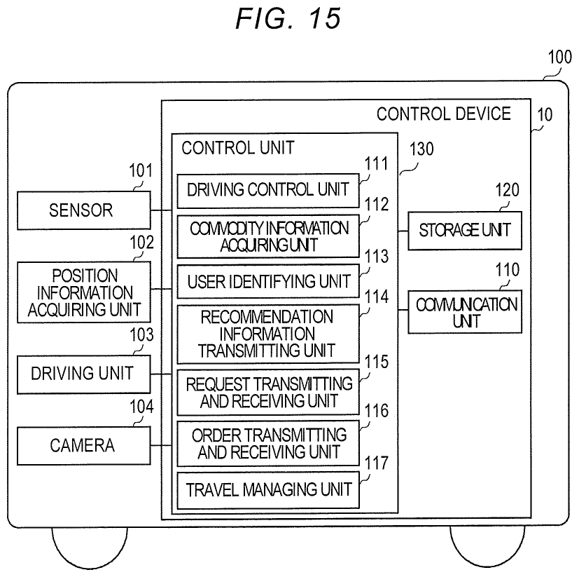

FIG. 15 is a block diagram schematically illustrating an example of a vehicle 100 according to the fourth embodiment. The vehicle 100 according to this embodiment includes a camera 104 in addition to the configuration according to the first embodiment illustrated in FIG. 2. The camera 104 is disposed to capture an image of the surroundings of the vehicle 100 such as the front, rear, right, and left sides of the vehicle 100. The camera 104 may be common to a drive recorder or a camera that captures an image of the surroundings to support driving.

The control device 10 according to this embodiment includes an imaging control unit 118 in addition to the configuration illustrated in FIG. 2.

The imaging control unit 118 acquires a position of a shop in a shop table, acquires a current position of the host vehicle 100 from the position information acquiring unit 102, and causes the camera 104 to image the shop when it is determined that the host vehicle 100 approaches the shop, that is, is within a predetermined distance (for example, 30 to 100) in which the shop can be imaged based on the position of the shop and the current position. Then, the recommendation information transmitting unit 114 generates second information based on the captured image of the shop and the first information. For example, the captured image is added to information of commodities indicated by the first information to generate second information. Characters may be recognized from the captured image, and character information may be acquired from a sign or a menu in the captured image and added to the second information.

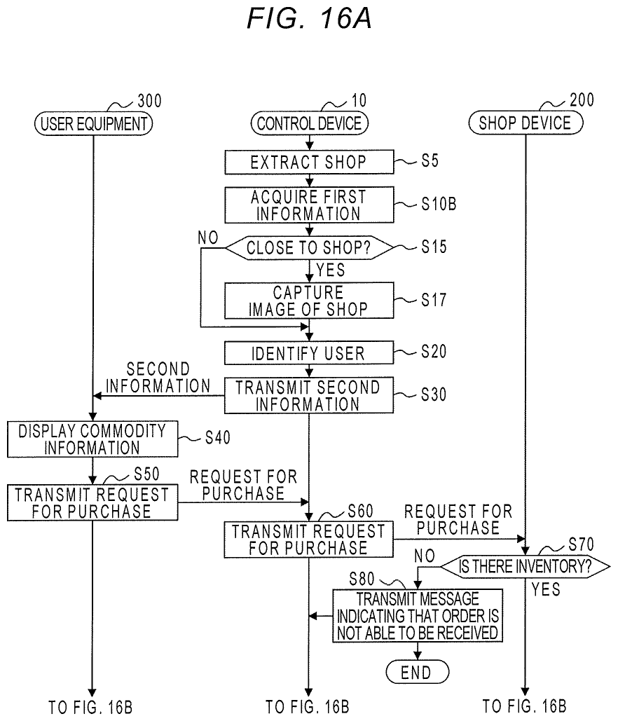

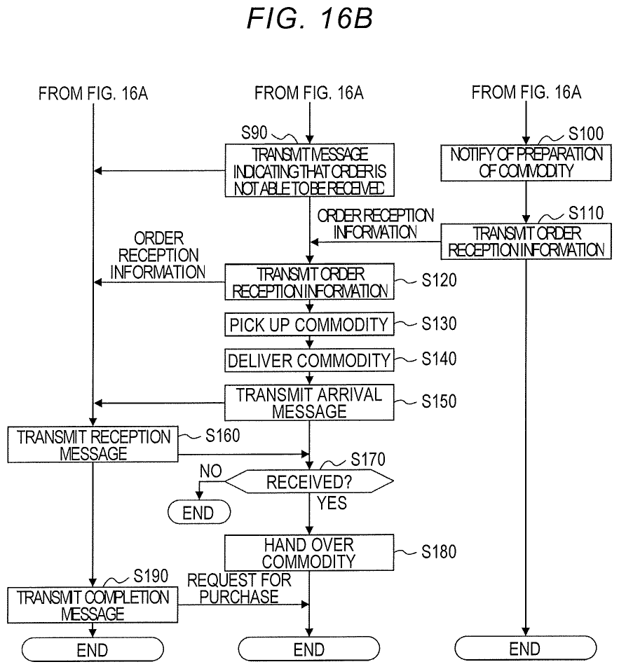

FIGS. 16A and 16B are diagrams illustrating a mail-order method according to the fourth embodiment. The control device 10 starts the process routine illustrated in FIGS. 16A and 16B at a predetermined time such as a predetermined period or a specific time. The processes of Steps S5 and S10B are the same as illustrated in FIG. 14.

After Step S10B, the imaging control unit 118 of the control device 10 determines whether the host vehicle 100 approaches the shop based on the position of the shop acquired from the shop table and the current position acquired from the position information acquiring unit 102 (Step S15). When the determination result of Step S15 is positive, the imaging control unit 118 causes the camera 104 to image the shop (Step S17). On the other hand, when the determination result of Step S15 is negative, the imaging control unit 118 does not perform imaging but performs Step S20.

In Step S20, the user identifying unit 113 of the control device 10 identifies a user based on a route that the vehicle 100 is scheduled to travel similarly to FIG. 9.

When a captured image is not acquired in Step S17, the recommendation information transmitting unit 114 of the control device 10 generates second information from the first information and transmits the generated second information to the user equipment similarly to the above description. When a captured image is acquired in Step S17, the recommendation information transmitting unit 114 adds the captured image to the information of commodities indicated by the first information to generate second information and transmits the second information to the user equipment (Step S30A). The processes of Step S40 and steps subsequent thereof are the same as described above with reference to FIG. 14 and thus description thereof will not be repeated.

In this way, in this embodiment, since a captured image of a shop is added to second information and the second information is transmitted to a user, the user can ascertain a situation of the shop and perform ordering. For example, when a user ascertains that a parking lot of the shop is full or that many users are lined, the user can determine that delivery using a vehicle 100 is better than visiting of the shop directly.

### OTHERS

The processes or units which have been described above in the present disclosure can be freely combined as long as no technical contradictions arise.

A process which has been described to be performed by a single device may be distributed to and performed by a plurality of devices. Alternatively, processes which have been described to be performed by different devices may be performed by a single device. In a computer system, by what hardware configuration (server configuration) each function is to be embodied can be flexibly changed.

The disclosure can also be embodied by supplying a computer program storing the functions described above in the above-mentioned embodiment to a computer and causing one or more processors of the computer to read and execute the computer program. Such a computer program may be provided to the computer via a non-transitory computer-readable storage medium which can access a system bus of the computer or may be provided to the computer via a network. Examples of the non-transitory computer-readable storage medium include an arbitrary type of disk such as a magnetic disk (such as a Floppy (registered trademark) disk or a hard disk drive (HDD)) or an optical disc (such as a CD-ROM, a DVD disc, or a blue-ray disc), a read only memory (ROM), a random access memory (RAM), an EPROM, an EEPROM, a magnetic card, a flash memory, an optical card, and an arbitrary type of medium which is suitable for storing electronic commands.

What is claimed is:

1. A processing device comprising a control unit configured to perform:
acquiring first information on one or more commodities of which purchase is to be recommended based on a travel schedule of a vehicle;
identifying one or more users based on a route that the vehicle is scheduled to travel;
transmitting second information for recommending purchase of the one or more commodities based on the first information to the identified user; and
controlling travel of the vehicle such that a commodity is picked up and is then delivered to a user who has returned a reply of desiring purchase of the commodity when the reply has been returned from the user.

2. The processing device according to claim 1, wherein the control unit is configured to acquire the first information from a web page of a shop which is identified based on the travel schedule of the vehicle.

3. The processing device according to claim 2, wherein the control unit is configured to generate the second information based on an image from the traveling vehicle having imaged the shop and the first information.

4. The processing device according to claim 1, wherein the control unit is configured to acquire a time at which the commodity is delivered to the user based on the route and to notify the user of the time.

5. A processing method of causing an information processing device to perform:
acquiring first information on one or more commodities of which purchase is to be recommended based on a travel schedule of a vehicle;
identifying one or more users based on a route that the vehicle is scheduled to travel;
transmitting second information for recommending purchase of the one or more commodities based on the first information to the identified user; and
controlling travel of the vehicle such that a commodity is picked up and is then delivered to a user who has returned a reply of desiring purchase of the commodity when the reply has been returned from the user.

6. A program causing an information processing device to perform:
acquiring first information on one or more commodities of which purchase is to be recommended based on a travel schedule of a vehicle;
identifying one or more users based on a route that the vehicle is scheduled to travel;
transmitting second information for recommending purchase of the one or more commodities based on the first information to the identified user; and
controlling travel of the vehicle such that a commodity is picked up and is then delivered to a user who has returned a reply of desiring purchase of the commodity when the reply has been returned from the user.
